(19) United States
(12) Patent Application Publication
(10) Pub. No.: US 2009/0302565 A1
(43) Pub. Date: Dec. 10, 2009

(54) BRAKE SYSTEM AND METHOD AND TWO-WHEELED VEHICLE USING THE SAME

(75) Inventor: Andrew Ouellet, Alameda, CA (US)

Correspondence Address: Chih Feng Yeh;BRIAN M. MCINNIS, 12th Floor, Ruttonjee House, 11 Duddell Street, Hong Kong, HK

(73) Assignee: CONCEPTUALIZED ENGINEERING, LTD., San Luis Obispo, CA (US)

(21) Appl. No.: 12/477,888

(22) Filed: Jun. 3, 2009

Related U.S. Application Data
(60) Provisional application No. 61/059,096, filed on Jun. 5, 2008.

(51) Int. Cl. B62D 61/02; B62L 3/08; F16C 1/10

(52) U.S. Cl. 280/63; 188/24.22; 74/500.5

(57) ABSTRACT

In the specification and drawing a new brake system and a two-wheeled vehicle using the same are described. The new brake system includes a first brake to apply a first brake force on a first wheel of a vehicle and transfers the first brake force to physically actuate a second brake to brake a second wheel of the vehicle. A transmission device is disclosed to transfer the first brake force to actuate the second brake.

### RELATED APPLICATIONS

This application claims priority to a Provisional Application Ser. No. 61/059,096, filed Jun. 5, 2008, which are herein incorporated by reference.

### BACKGROUND

1. Field of Invention

The present invention relates a brake system and method. More particularly, the present invention relates to a brake system and method for a two-wheeled vehicle.

2. Description of Related Art

A two-wheeled vehicle is equipped with a brake system to slow or stop its moving by applying friction upon its wheels. A rider uses both hands to press two brake levers, fixed on the handlebar, to control a front and rear brake of the two-wheeled vehicle. However, it would be dangerous if the rider press either one of the brake levers too hard to make the vehicle's wheel to be locked by the front or rear brake. It is uncontrollable and dangerous for a moving two-wheeled vehicle with one of its wheels being locked, e.g. the vehicle may skid on the ground. In the instance of a two-wheeled vehicle's tip over, the two-wheeled vehicle still moves with its front wheel being locked such that the rider may fall over beyond a handlebar of the two-wheeled vehicle when a rear wheel comes off the ground by a sufficient height. For the forgoing reasons, there is a need for preventing a moving two-wheeled vehicle from a tip-over or a wheel being locked.

### SUMMARY

In one aspect of the present invention, a vehicle braking method includes actuating a first brake to apply a first brake force on a first wheel of a vehicle, and transferring the first brake force to physically actuate a second brake to brake a second wheel of the vehicle.

In another aspect of the present invention, a brake system includes the following elements. A first brake is used to apply a first brake force on a first wheel. A second brake is used to brake a second wheel. A transmission device is used to transfer the first brake force to actuate the second brake, wherein the transmission device includes the following elements. A support bracket is secured to a frame of a two-wheeled vehicle. An actuating member is movably connected with the support bracket, wherein the actuating member has an end secured to the first brake and an opposite end to actuate a brake cable of the second brake.

In still another aspect of the present invention, a two-wheeled vehicle includes the following elements. The frame has a handlebar. The front wheel and a rear wheel are rotatably connected with the frame. The rear brake is to apply a first brake force on the rear wheel and has a first brake cable. The front brake is to brake the front wheel and has a second brake cable. A brake lever is secured to the handlebar and used to pull the first brake cable to actuate the rear brake. A means for transferring the first brake force to pull the second brake cable is used to actuate the front brake.

In still another aspect of the present invention, a bicycle includes the following elements. A frame has a handlebar. A front wheel and a rear wheel are rotatably connected with the frame. A rear brake is to apply a first brake force on the rear wheel and has a first brake cable. A front brake is to brake the front wheel and has a second brake cable. A brake lever is disposed on the handlebar and used to pull the first brake cable to actuate the rear brake. A transmission device is used to transfer the first brake force to actuate the second brake, wherein the transmission device includes the following elements. A support bracket is secured to the frame. An actuating member is movably connected with the support bracket, wherein the actuating member has an end secured to the rear brake and an opposite end to actuate the second brake cable.

Thus, the new brake system provides a new braking way—using a first brake force of a first brake to physically actuate a second brake to brake a second wheel. This new braking way is able to solve a two-wheeled vehicle's tip-over, that is, to prevent a front brake from being locked. Moreover, the new braking way permits the rider to use either one hand to press single brake lever so as to actuate two brakes upon front and rear wheels.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a bicycle according to one embodiment of this invention;

FIG. 2 illustrates a brake system according to one embodiment of this invention;

FIG. 3 illustrates a brake system according to another embodiment of this invention;

FIG. 4 illustrates a rear brake and a transmission device according to one embodiment of this invention;

FIG. 5 illustrates a rear brake and a transmission device according to another embodiment of this invention;

FIG. 6 illustrates a rear brake and a transmission device according to still another embodiment of this invention;

FIG. 7 illustrates a rear brake and a transmission device according to still another embodiment of this invention; and

FIG. 7A illustrates a cross-sectional view taken along A-A′ in FIG. 7.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

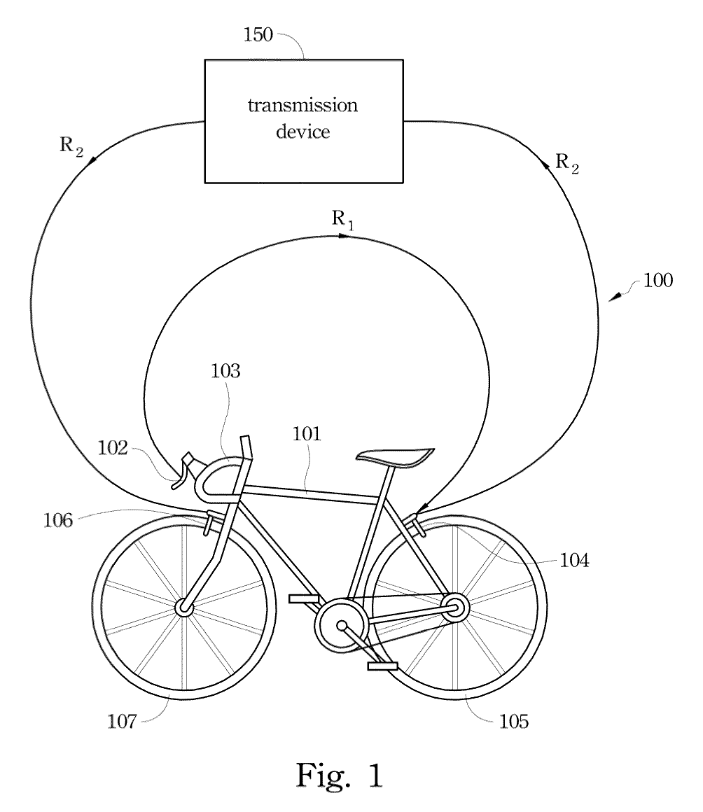

FIG. 1 illustrates a bicycle according to one embodiment of this invention. A new brake system is implemented on the bicycle 100 to prevent a tip-over instance in which a front wheel is locked, i.e. cannot rotate or hardly rotate relative to a front brake, when the bicycle still moves. The bicycle 100 has a frame 101 on which a front wheel 107 and a rear wheel 105 are rotatably mounted. In a first braking route R₁ of this embodiment, a rear brake 104 is actuated by a brake lever 102 fastened on a handlebar 103 of a bicycle frame so as to apply a brake force on a rear wheel 105, i.e. by squeezing the rear brake 104 upon a rim of the rear wheel 105. In a second braking route R₂ of this embodiment, the brake force (friction between the rear brake 104 and the rear wheel 105) is transferred by a transmission device 150 to physically actuate the front brake 106 so as to brake a front wheel 107, i.e. by squeezing the front brake 106 upon a rim of the front wheel 107. By “physically”, it means, “to actuate the brake in a way able to be touched and seen, rather than something unable to be touched and seen, e.g. an electrical signal”. That is, the transmission device 150 utilizes a pure physical way to transfer a brake force of a brake to actuate another brake. The transmission device 150 is one means for transferring the first brake force to pull the second brake cable, as recited in claims. Since the front brake 106 is actuated by the rear brake force, the front brake 106 would not be locked when no rear brake force occurs. In the instance of a bicycle's tip-over being liable to happen, the rear wheel coming off the ground would results in almost no rear brake force, thereby releasing the front brake 106. Therefore, the rear wheel is allowed to be stayed on the ground again and a bicycle's tip-over is prevented.

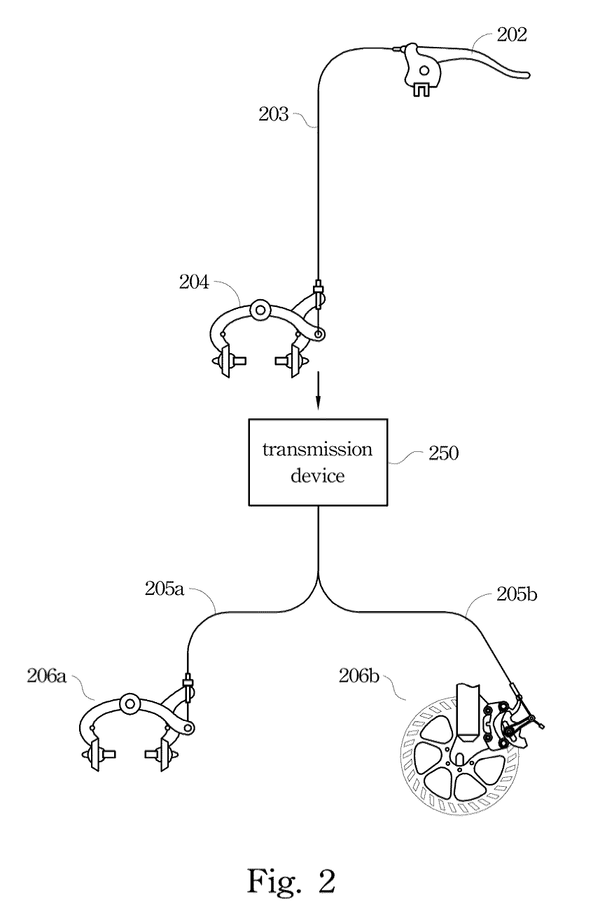

FIG. 2 illustrates a brake system according to one embodiment of this invention. The new brake system includes a brake lever 202, a first brake 204 (a rim brake), a transmission device 250 and a second brake 206a (a rim brake) or 206b (a disc brake). The brake lever 202 is controlled by a rider to actuate the first brake 204 through a brake cable 203. The transmission device 250 is to proportionally transfer a brake force of the first brake 204 to actuate the second brake 206a or 206b through respective brake cables 205a or 205b. The transmission device 250 is one means for transferring the first brake force to pull the second brake cable, as recited in claims. In the embodiment of FIG. 1, the first brake 204 is a rear brake and the second brake 206a or 206b is a front brake. In an alternate embodiment, the first brake 204 may be a front brake and the second brake 206a or 206b may be a rear brake. In such case, the transmission device 250 may be used to proportionally transfer the first brake 204 (a front brake) to actuate the second brake 206a or 206b (a rear brake) such that the front brake has a larger brake force than the rear brake does. In case a proper front/back brake ratio is applied upon front, rear wheels, a bicycle's tip-over can be prevented in a different way.

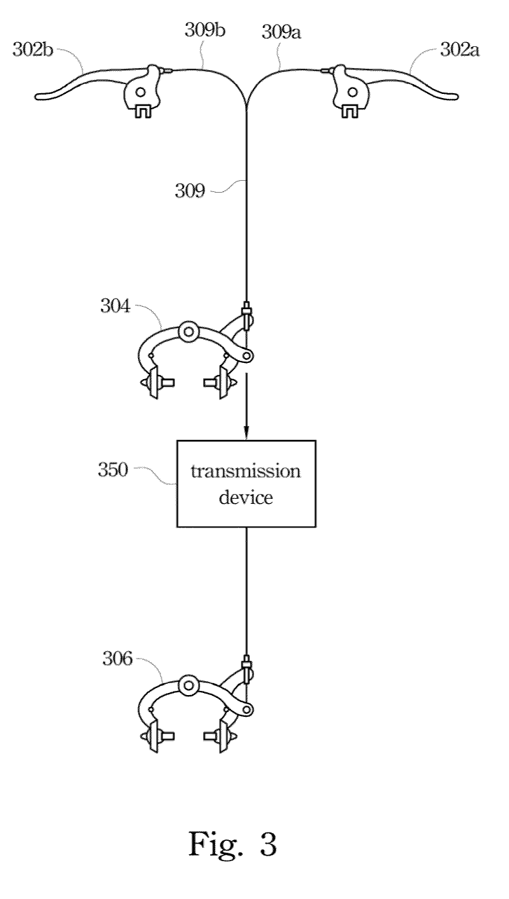

FIG. 3 illustrates a brake system according to another embodiment of this invention. The new brake system may include two brake levers (302a, 302b), a first brake 304, a transmission device 350 and a second brake 306. In this embodiment, two brake levers (302a, 302b) are used to actuate the first brake 304 where a wire core 309a and a wire core 309b are bonded to commonly pull a wire core 309. This design shares a pull force of the wire core 309b with two wire cores (309a, 309b), which are respectively pulled by two brake levers (302a, 302b). Thus, a rider may use both hands to apply less force on two brake levers (302a, 302b) to actuate the first brake 304. However, it is still proper to use either one of two brake levers (302a, 302b) to actuate the first brake 304. The transmission device 350 is to proportionally transfer a brake force of the first brake 304 to actuate the second brake 306. The transmission device 350 is one means for transferring the first brake force to pull the second brake cable, as recited in claims.

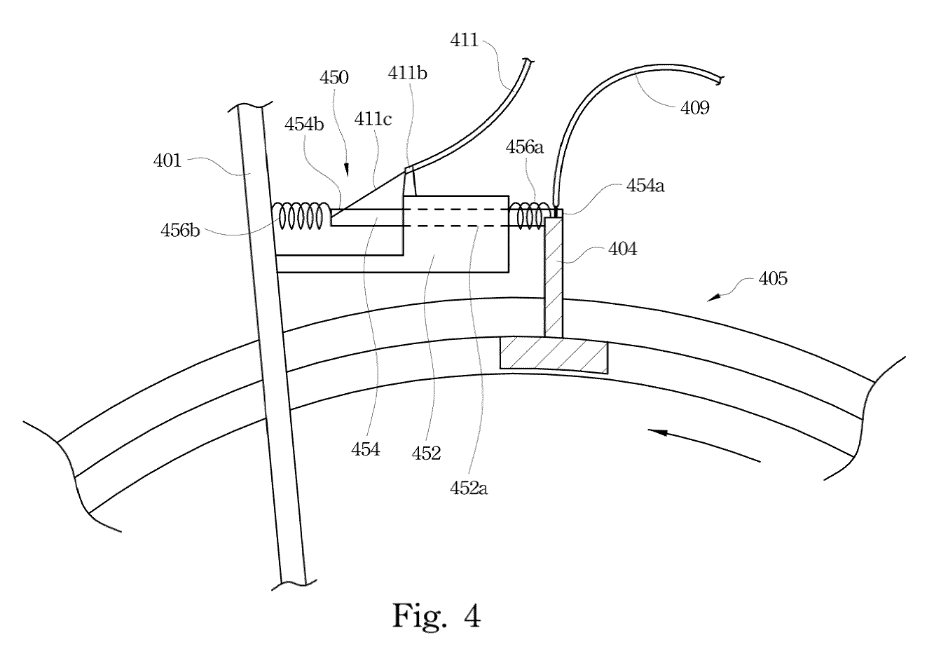

FIG. 4 illustrates a rear brake and a transmission device according to one embodiment of this invention. This Figure embodies the first brake (104, 204, 304) as a rear rim brake 404, which is actuated through a brake cable 409. The transmission device 450 is one means for transferring the first brake force to pull the second brake cable, as recited in claims. In this embodiment, the transmission device 450 transfers a brake force of the rear brake 404 to pull a wire core 411c of the brake cable 411. The transmission device 450 includes a support bracket 452, an actuating member 454 and a resilient member (456a or 456b). The support bracket 452 is secured to a frame 401 of a two-wheeled vehicle, i.e. a bicycle or motorcycle. The actuating member 454 is movably, e.g. slidably, connected within a through hole 452a of the support bracket 452. The actuating member 454 has an end 454a fixed to the rear brake 404 and an opposite end 454b connected with the wire core 411c. A bearing may be installed within the through hole 452a (not illustrated in the drawings) to permit the actuating member 454 to be smoothly slid relative to the support bracket 452. The resilient member 456a has an end secured to an end 454a of the actuating member 454 and an opposite end secured to the support bracket 452. The resilient member 456b has an end secured to an end 454b of the actuating member 454 and an opposite end secured to the frame 401. The both resilient members (456a, 456b) or either one of them can be used to press the actuating member 454 against a brake force of the rear brake 404. When the rear brake 404 is actuated to brake the rear wheel 405, the brake force of the rear brake 404 drives the actuating member 454 against the resilient member (456a, 456b) to pull the wire core 411c of the brake cable 411. Therefore, a front brake can be actuated by the pulled wire core 411c. When the rear brake 404 is not actuated, i.e. no contact between the rear brake 404 and the rear wheel 405, the resilient member returns the actuating member 454 to an original position. In the instance of the rear wheel 405 coming off the ground, the rear brake 404 is actuated to brake the rear wheel 405, but the resilient member still returns the actuating member 454 to an original position, thereby releasing the wire core 411c of the brake cable 411 and the front brake. The brake cable 411 has an end 411b secured to the support bracket 452 and an opposite end (not illustrated in this figure) secured to a front brake, e.g. reference numeral 106 in FIG. 1.

In an alternate embodiment, the resilient members (456a, 456b) may be removed. The front brake has resilient members (such as spring) in itself that keep tension in the wire core 411c. The resilient members also lift the brake pads off the rims. That force puts tension in the wire core 411c and is usually enough to return the actuating member 454 to its original position. If the resilient members in the front brake are not strong enough, then one can be added to the transmission device 450.

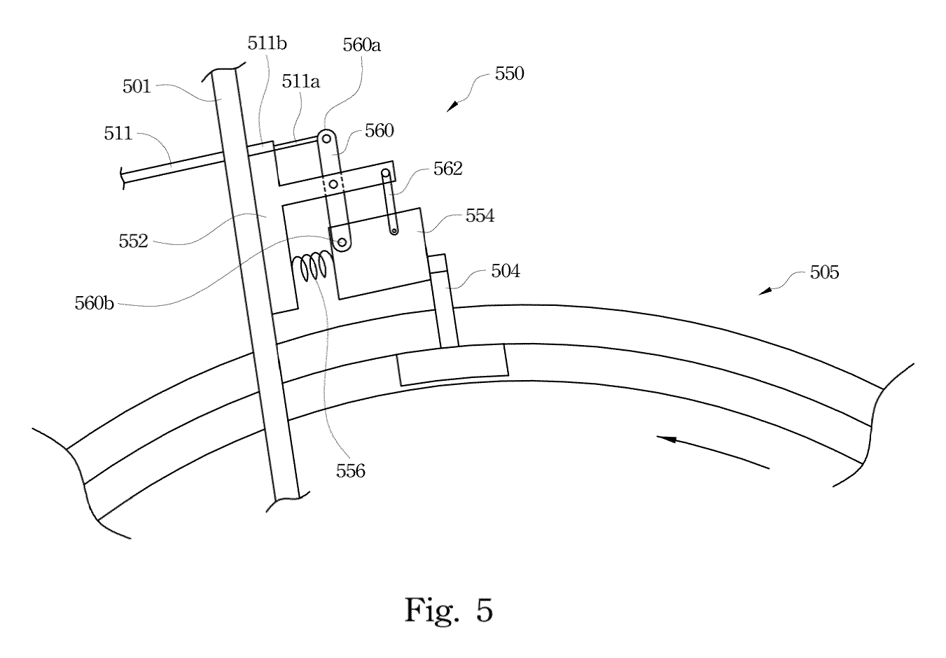

FIG. 5 illustrates a rear brake and a transmission device according to another embodiment of this invention. This Figure embodies the first brake (104, 204, 304) as a rear rim brake 504 (a brake cable of the rear rim brake 504 is omitted). The transmission device 550 is one means for transferring the first brake force to pull the second brake cable, as recited in claims. In this embodiment, the transmission device 550 transfers a brake force of the rear brake 504 to pull a wire core 511a of the brake cable 511. The transmission device 550 includes a support bracket 552, an actuating member 554, a lever 560 and a resilient member 556. The support bracket 552 is secured to a frame 501 of a two-wheeled vehicle, i.e. a bicycle or motorcycle. The actuating member 554 is movably connected with the support bracket 552 by the lever 560 and a connection bar 562. The lever 560 has a middle section (a section excluding two ends of the lever 560), which is pivotally connected with the support bracket 552. In addition, the lever 560 has an end 560a connected with the wire core 511a of the brake cable 511 and an opposite end 560b pivotally connected with the actuating member 554. The rear brake 504 is fixed to the actuating member 554. The resilient member 556 has an end secured to the actuating member 554 and an opposite end secured to the support bracket 552. When the rear brake 504 is actuated to brake the rear wheel 505, the brake force of the rear brake 504, i.e. friction between the rear wheel 505 and the rear brake 504, moves the rear brake 504 itself and drives the actuating member 554 against the resilient member 556 to push the end 560b of the lever 560 and the opposite end 560a of the lever 560 then pulls the wire core 511a of the brake cable 511. The lever 560 herein is to proportionally transfer the brake force of the rear brake 504 to pull the brake cable 511 by an action of levering. Therefore, a front brake can be actuated by the pulled wire core 511a. When the rear brake 504 is not actuated, i.e. no contact between the rear brake 504 and the wheel 505, the resilient member 556 returns the actuating member 554 to an original position. In the instance of the rear wheel 505 coming off the ground, the rear brake 504 is actuated to brake the rear wheel 505, but the resilient member 556 still returns the actuating member 554 to an original position, thereby releasing the wire core 511a of the brake cable 511. The brake cable 511 has an end 511b secured to the support bracket 552 and an opposite end (not illustrated in this figure) secured to a front brake, e.g. reference numeral 106 in FIG. 1.

In an alternate embodiment, the resilient member 556 may be removed. The front brake has resilient members (such as spring) in itself that keep tension in the wire core 511c. The resilient members also lift the brake pads off the rims. That force puts tension in the wire core 511c and is usually enough to return the actuating member 554 to its original position. If the resilient members in the front brake are not strong enough, then one can be added to the transmission device 550.

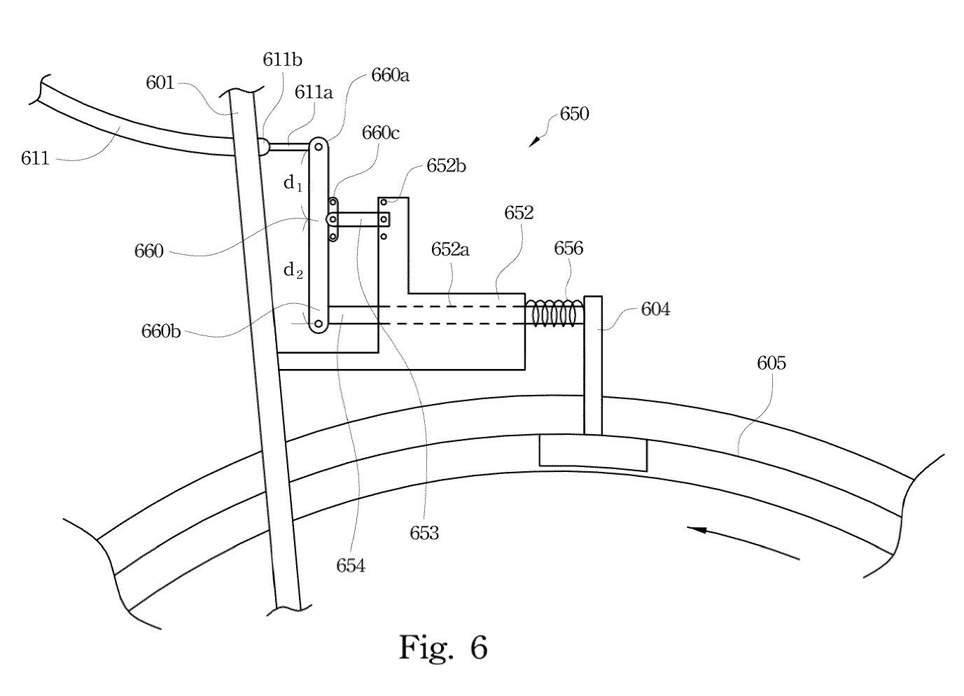

FIG. 6 illustrates a rear brake and a transmission device according to still another embodiment of this invention. This Figure embodies the first brake (104, 204, 304) as a rear rim brake 604 (a brake cable of the rear rim brake 604 is omitted). The transmission device 650 is one means for transferring the first brake force to pull the second brake cable, as recited in claims. In this embodiment, the transmission device 650 transfers a brake force of the rear brake 604 to pull a wire core 611a of the brake cable 611. The transmission device 650 includes a support bracket 652, an actuating member 654, a lever 660 and a resilient member 656. The support bracket 652 is secured to a frame 601 of a two-wheeled vehicle, i.e. a bicycle or motorcycle. The actuating member 654 is movably, e.g. slidably, connected within a through hole 652a of the support bracket 652. A bearing may be installed within the through hole 652a (not illustrated in the drawings) to permit the actuating member 654 to be smoothly slid relative to the support bracket 652. The lever 660 has a middle section, i.e. a section excluding two ends of the lever 660, pivotally connected with a connection bar 653, which is further pivotally connected with the support bracket 652. When the lever 660 swings to and fro, the connection bar 653 would slightly tilt up and down. In addition, the lever 660 has an end 660a connected with the wire core 611a of the brake cable 611 and an opposite end 660b pivotally connected with the actuating member 654. The lever 660 herein is to proportionally transfer the brake force of the rear brake 604 to pull the brake cable 611 by an action of levering. The rear brake 604 is fixed to the actuating member 654. The resilient member 656 has an end secured to the actuating member 654 and an opposite end secured to the support bracket 652. When the rear brake 604 is actuated to brake the rear wheel 605, the brake force of the rear brake 604, i.e. friction between the rear wheel 605 and the rear brake 604, drives the actuating member 654 against the resilient member 656 to push the end 660b of the lever 660 and the opposite end 660a of the lever 660 then pulls the wire core 611a of the brake cable 611. Therefore, a front brake can be actuated by the pulled wire core 611a. When the rear brake 604 is not actuated, i.e. no contact between the rear brake 604 and the wheel 605, the resilient member 656 returns the actuating member 654 to an original position. In the instance of the rear wheel 605 coming off the ground, the rear brake 604 is actuated to brake the rear wheel 605, but the resilient member 656 still returns the actuating member 654 to an original position, thereby releasing the wire core 611a of the brake cable 611. The brake cable 611 has an end 611b secured to the frame 601 and an opposite end (not illustrated in this figure) secured to a front brake, e.g. reference numeral 106 in FIG. 1.

In an alternate embodiment, the resilient member 656 may be removed. The front brake has resilient members (such as spring) in itself that keep tension in the wire core 611a. The resilient members also lift the brake pads off the rims. That force puts tension in the wire core 611a and is usually enough to return the actuating member 654 to its original position. If the resilient members in the front brake are not strong enough, then one can be added to the transmission device 650.

In the embodiment of FIG. 6, a leverage ratio adjusting mechanism is used to adjust a leverage ratio of the lever 660. The leverage ratio adjusting mechanism is one means for adjusting a leverage ratio of the lever, as recited in claims. In particular, the lever 660 has three pivot holes 660a while the support bracket 652 has three fastening holes 652b. The connection bar 653 can be selectively to interconnect (the upper pivot hole 660a and the upper fastening hole 652b), or (the intermediate pivot hole 660a and the intermediate fastening hole 652b), or (the lower pivot hole 660a and the lower fastening hole 652b) such that the lever 660 can have three different leverage ratios. Moreover, the connection bar 653 can be mode longer or shorter, as well as changing the length, e.g. d₁ or d₂, of the lever 660 to achieve a desired leverage ratio. In an alternate embodiment, the leverage ratio adjusting mechanism may have two, four or more sets of pivot holes and fastening holes to permit the connection bar 653 to be interconnected with.

In order for any vehicle to achieve the minimum possible stopping distance, (neglecting skidding of the front tire(s)), 100% of the braking force should be applied to the front brake, and the rear wheel should be kept just barely off the ground. This however, is not practical or safe. No vehicles use only front brakes because it is dangerous and causes excessive wear. The brake system disclosed herein attempts to mimic a safe and efficient front/back brake ratio of approximately 75/25. This has been found to be most preferred by test riders, allowing the rider to stop quickly and effortlessly, yet not making the brakes overly touchy.

The front/rear brake ratio can be tuned by the above-mentioned leverage ratio adjusting mechanism. The optimum ratio best suited for most riders has been a 70/30 front/back brake ratio in the beginning of the lever stroke, and ending with an 80/20 front/back brake ratio towards the end of the lever stroke. At this 80/20 leverage ratio, the rider must only supply the 20% of the braking force needed to the rear tire. The system then magnifies that force 4 times and directs it to the front brake. Because a rider only must supply 20% of the braking force, the strength required for a rider to stop quickly in minimal distance is greatly decreased, allowing inexperienced and weaker riders to stop quickly and safely.

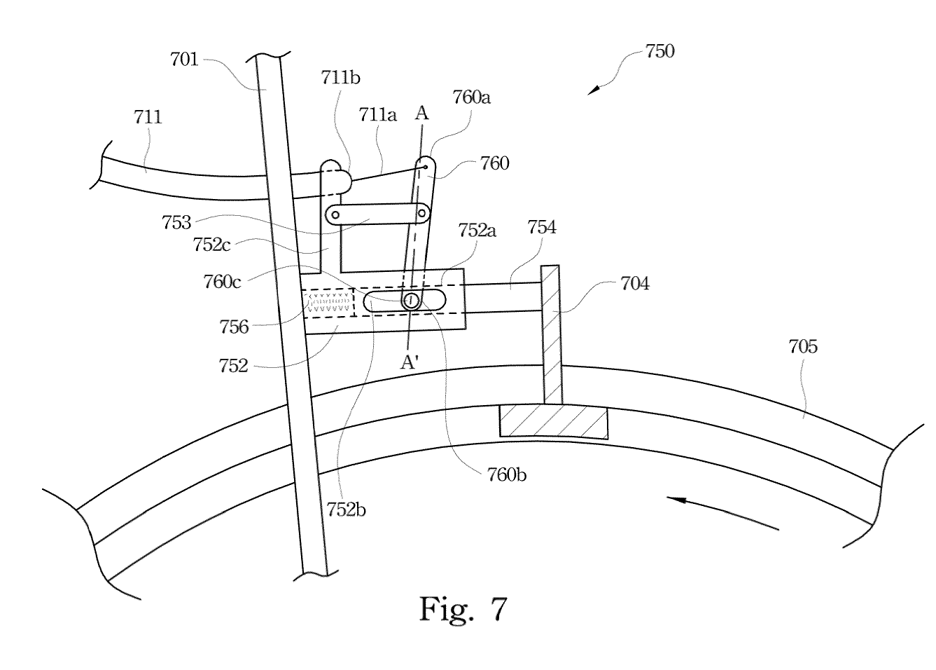

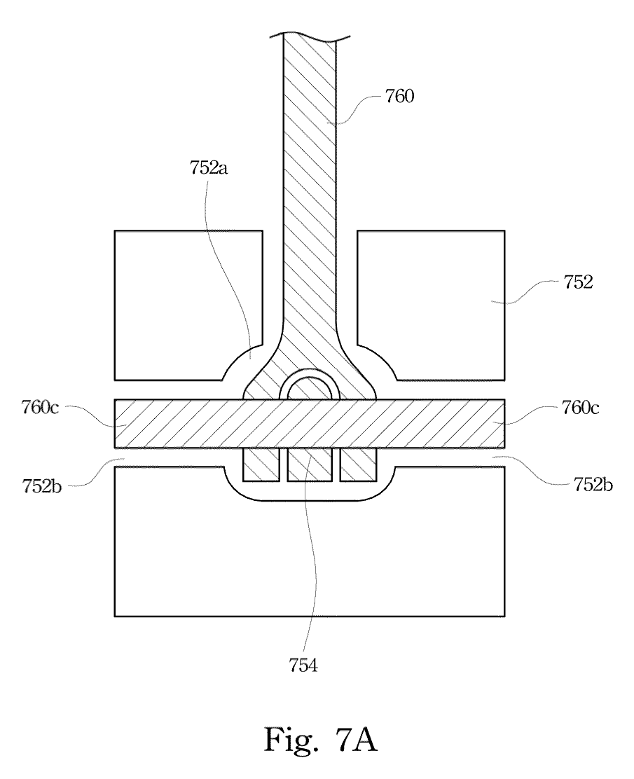

FIG. 7 illustrates a rear brake and a transmission device according to still another embodiment of this invention. FIG. 7A illustrates a cross-sectional view taken along A-A′ in FIG. 7. These two Figures embody the first brake (104, 204, 304) as a rear rim brake 704 (a brake cable of the rear rim brake 704 is omitted). The transmission device 750 is one means for transferring the first brake force to pull the second brake cable, as recited in claims. In this embodiment, the transmission device 750 transfers a brake force of the rear brake 704 to pull a wire core 711a of the brake cable 711. The transmission device 750 includes a support bracket 752, an actuating member 754, a lever 760 and a resilient member 756. The support bracket 752 is secured to a frame 701 of a two-wheeled vehicle, i.e. a bicycle or motorcycle. The actuating member 754 is movably, e.g. slidably, connected within a through hole 752a of the support bracket 752. The support bracket 752 further includes a hollow slot 752b to permit a pivot pin 760c to be slid within, thereby restricting the lever 760 and the actuating member 754 to be moved within a predetermined distance. The pivot pin 760c is to pivotally interconnect the actuating member 754 and the lever 760, i.e. the pivot pin 760c penetrates through the actuating member 754 and the lever 760. Two fasteners (not illustrated in the drawings) may be attached on two ends of the pivot pin 760c to prevent it from slipping off from the actuating member 754 and the lever 760. The lever 760 has a middle section, i.e. a section excluding two opposite ends of the lever 760, pivotally connected with a connection bar 753. The connection bar 753 is further pivotally connected with an upper arm 752c of the support bracket 752. The connection bar 753 can be mode longer or shorter, as well as changing the length of the lever 760 to achieve a desired leverage ratio. When the lever 760 swings to and fro, the connection bar 753 would slightly tilt up and down. In addition, the lever 760 has an end 760a connected with the wire core 711a of the brake cable 711 and an opposite end 760b pivotally connected with the actuating member 754. The lever 760 herein is to proportionally transfer the brake force of the rear brake 704 to pull the brake cable 711 by an action of levering. The rear brake 704 is fixed to the actuating member 754. The resilient member 756, which is located within the through hole 752a, has an end secured to the actuating member 754 and an opposite end secured to the support bracket 752. When the rear brake 704 is actuated to brake the rear wheel 705, the brake force of the rear brake 704, i.e. friction between the rear wheel 705 and the rear brake 704, drives the actuating member 754 against the resilient member 756 to push the end 760b of the lever 760 and the opposite end 760a of the lever 760 then pulls the wire core 711a of the brake cable 711. Therefore, a front brake can be actuated by the pulled wire core 711a. When the rear brake 704 is not actuated, i.e. no contact between the rear brake 704 and the wheel 705, the resilient member 756 returns the actuating member 754 to an original position. In the instance of the rear wheel 705 coming off the ground, the rear brake 704 is actuated to brake the rear wheel 705, but the resilient member 756 still returns the actuating member 754 to the original position, thereby releasing the wire core 711a of the brake cable 711. The brake cable 711 has an end 711b fastened to a top end of the upper arm 752c and an opposite end (not illustrated in this figure) secured to a front brake, e.g. reference numeral 106 in FIG. 1.

In an alternate embodiment, the resilient member 756 may be removed. The front brake has resilient members (such as spring) in itself that keep tension in the wire core 711a. The resilient members also lift the brake pads off the rims. That force puts tension in the wire core 711a and is usually enough to return the actuating member 754 to its original position. If the resilient members in the front brake are not strong enough, then one can be added to the transmission device 750.

Although the embodiments in FIG. 4, FIG. 5, FIG. 6 and FIG. 7 are implemented as a rear rim brake, the same designs or structures can also be implemented on a disk brake or on a front brake. For example, if the transmission devices 450, 550, 650 and 750 are implemented on a front brake, the support brackets 450, 550, 650 and 750 can be secured to a front fork of a two-wheeled vehicle. If the transmission devices 450, 550, 650 and 750 are implemented on a disk brake, the support brackets 450, 550, 650 and 750 can be secured to a frame and close to a hub of a front wheel or a rear wheel such that the brake can be used to squeeze the brake disk of the front or rear wheel, instead of a rim of the front or rear wheel.

According above-discussed embodiments, the brake system disclosed herein tunes the front braking force so quickly that the rear wheel never has a chance to lift off the ground. Once the rear wheel starts to skid, the system immediately releases the correct amount of tension in the front brake cable, thereby keeping the rear wheel on the ground, reducing the skid, and still stopping in the shortest possible distance. Because of this feature, a rider's ability to stop in a short distance is not determined by his/her strength or skill, and rider error has been effectively removed.

In addition, the failsafe design of the brake system insures that the rear brake will remain functional should something within the brake system or the front brake malfunction. Also, the brake system compensates for slippery/wet conditions and helps to eliminate the front tire skidding and coming out from under a rider during turns on wet/slick surfaces.

Therefore, the brake system disclosed herein is a dynamic, tunable, real time braking system that compensates for every situation instantaneously and under any road conditions. It is also a brake system that is capable of protecting the rider from his/herself in the event of a panic stop where too much braking force is applied. The brake system reduces just enough front brake force to keep the rear wheel on the ground, yet keeps just enough brake force to allow the rider to slow in the least possible distance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1-6. (canceled)

7. A brake system comprising:
a first brake for applying a first brake force on a first wheel, wherein the first brake comprises a rim brake or a disc brake;
a second brake for braking a second wheel and comprising a brake cable; and
a transmission device for transferring the first brake force to actuate the second brake, wherein the transmission device comprises:
a support bracket secured to a frame of a two-wheeled vehicle; and
an actuating member being movably connected with the support bracket, wherein the actuating member has an end secured to the first brake and an opposite end to actuate the brake cable of the second brake.

8. The brake system of claim 7, wherein the transmission device further comprises a lever, which comprises:
a middle section pivotally connected with the support bracket;
a first end connected with the brake cable; and
a second opposite end pivotally connected with the opposite end of the actuating member.

9. The brake system of claim 7, wherein the actuating member is slidably connected within the support bracket.

10. The brake system of claim 7, wherein the second brake comprises a rim brake or a disc brake.

11. The brake system of claim 7, wherein the transmission device further comprising:
a resilient member being interconnected between the actuating member and the support bracket, or interconnected between the actuating member and the frame.

12. A two-wheeled vehicle comprising:
a frame comprising a handlebar;
a front wheel and a rear wheel being rotatably mounted on the frame;
a rear brake for applying a first brake force on the rear wheel and comprising a first brake cable, wherein the rim brake comprises a rim brake or a disc brake;
a front brake for braking the front wheel and comprising a second brake cable;
a brake lever being disposed on the handlebar and for pulling the first brake cable to actuate the rear brake; and
means for transferring the first brake force to pull the second brake cable so as to actuate the front brake.

13. The two-wheeled vehicle of claim 12, wherein the front brake comprises a rim brake or a disc brake.

14. A bicycle comprising:
a frame comprising a handlebar;
a front wheel and a rear wheel being rotatably mounted on the frame;
a rear brake for applying a first brake force on the rear wheel and comprising a first brake cable, wherein the rear brake comprises a rim brake or a disc brake;
a front brake for braking the front wheel and comprising a second brake cable;
a brake lever being disposed on the handlebar and for pulling the first brake cable to actuate the rear brake; and
a transmission device for transferring the first brake force to actuate the front brake, wherein the transmission device comprises:
a support bracket secured to the frame; and
an actuating member being movably connected with the support bracket, wherein the actuating member has an end secured to the rear brake and an opposite end to actuate the second brake cable.

15. The bicycle of claim 14, wherein the actuating member is slidably connected within the support bracket.

16. The bicycle of claim 14, wherein the front brake comprises a rim brake or a disc brake.

17. The bicycle of claim 14, wherein the transmission device further comprises a lever, which comprises:
a middle section pivotally connected with the support bracket;
a first end connected with the brake cable; and
a second opposite end pivotally connected with the opposite end of the actuating member.

18. The bicycle of claim 17, wherein the transmission device further comprises means for adjusting a leverage ratio of the lever.

19. The bicycle of claim 14, wherein the transmission device further comprises:
a resilient member being interconnected between the actuating member and the support bracket, or interconnected between the actuating member and the frame.

20. A transmission device for transferring a brake force of a first brake to actuate a second brake, the transmission device comprising:
a support bracket secured to a frame of a two-wheeled vehicle; and
an actuating member, being slidably connected within the support bracket, to be moved by the first brake when the first brake is actuated to brake a first wheel, wherein the actuating member has an end secured to the first brake and an opposite end to actuate a brake cable of the second brake.

21. The transmission device of claim 20 further comprising a lever, which comprises:
a middle section pivotally connected with the support bracket;
a first end connected with the brake cable; and
a second opposite end pivotally connected with the opposite end of the actuating member.

22. The transmission device of claim 21 further comprising means for adjusting a leverage ratio of the lever.

23. The transmission device of claim 21 further comprising a connection bar pivotally interconnected between the middle section and the support bracket.

24. The transmission device of claim 20 further comprising a resilient member being interconnected between the actuating member and the support bracket, or interconnected between the actuating member and the frame, to return the actuating member to an original position.

25. The brake system of claim 7, wherein the rim brake comprises a caliper brake.

26. The two-wheeled vehicle of claim 12, wherein the rim brake comprises a caliper brake.

27. The bicycle of claim 14. wherein the rim brake comprises a caliper brake.

28. A rear brake system comprising:
a rear brake;
a support bracket secured to a frame of a two-wheeled vehicle;
an actuating member, being movably connected with the support bracket, to he moved by the rear brake when the rear brake is actuated to brake a rear wheel, wherein the actuating member has an end secured to the rear brake and an opposite end to actuate a brake cable of a front brake; and
a lever comprising:
a middle section pivotally connected with the support bracket;
a first end connected with the brake cable; and
a second opposite end pivotally connected with the opposite end of the actuating member.

29. The rear brake system of claim 28, wherein the rear brake comprises a disc brake or a rim brake.

30. The rear brake system of claim 29, wherein e rim brake comprises a caliper brake.
